(19) United States
(12) Patent Application Publication
(10) Pub. No.: US 2010/0202376 A1
(43) Pub. Date: Aug. 12, 2010

(54) SCHEDULING OF VOICE OVER IP DATA

(75) Inventors: Yuan Zhu, Beijing (CN); Hai Ming Wang, Beijing (CN); Da Jie Jiang, Beijing (CN)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/669,946

(22) PCT Filed: Oct. 10, 2007
(86) PCT No.: PCT/FI2007/050551

§ 371 Date: Jan. 20, 2010

Related U.S. Application Data
(62) Division of application No. 11/881,484, filed on Jul. 26, 2007, now abandoned.

(51) Int. Cl. H04W 8/00

(52) U.S. Cl. 370/329

(57) ABSTRACT

Voice over Internet Protocol (VoIP) transfer is provided over radio links between mobile stations and base stations with a mechanism to schedule initial transmission within voice spurts when semi-persistent allocation of radio resources is employed. The radio link is changed during the voice spurt by allocating different physical resource blocks or by changing transmission parameters with given rescheduling intervals. The scheduling is informed from the base station to involved MS by using data link layer VoIP packet padding bits. The radio link can also be changed per initiative of the MS so that the MS codes a predetermined request into data link layer padding bits of an uplink VoIP packet. The requests from the MS typically involve a change of audio coding mode or informing of the present packet buffer status for VoIP packets at the MS.

### FIELD OF THE INVENTION

The present invention generally relates to transfer of voice over IP (VoIP) data on radio links. The invention relates particularly, though not exclusively, to semi-persistent scheduling of VoIP data on radio links between mobile stations and base stations in an Evolved Universal Terrestrial Radio Access (EUTRA) network.

### BACKGROUND OF THE INVENTION

VoIP is seen to be potentially one of the major applications in EUTRA systems, which systems are being designed as part of the Long-Term Evolution (LTE) within the 3rd Generation Partnership Project (3GPP). Regarding this, many system parameters of EUTRA are being optimized for VoIP. The EUTRA is based in Orthogonal Frequency Division Multiple Access (OFDMA), wherein a given amount of sub-carriers is allocated to users for predetermined periods of time. These sub-carriers allocated for predetermined periods are typically denoted as physical resource blocks (PRBs), with time and frequency dimensions. Allocation of PRBs is handled by a scheduling function at a 3GPP base station (so-called eNodeB).

Various contributions have addressed different aspects of VoIP on top of EUTRA. The EUTRA has limited resources for Open Systems Interconnection Basic Reference Model Layer 1 (OSI L1 or L1 in short) signalling and it is generally desired to spare those resources where possible. In so-called persistent scheduling, VoIP traffic is treated as circuit switched data so that VoIP packets on each data channel have dedicated scheduled slots. If no data needs to be conveyed in a particular slot, no other data can be scheduled therein. The persistent model is very simple in terms of directing the scheduling but this advantage is outweighed by the need to reserve roughly half of the radio resource unnecessarily.

Seeking to improve the persistent model, various contributions tie signalling overhead with scheduling flexibility in order to find most balanced working point for VoIP traffic on top of EUTRA system. Semi-persistent scheduling of VoIP traffic is one of the most promising techniques. OSI L3 RRC signalling or radio resource control plane signalling is typically used to define initial transmissions (normal repeated VoIP packets that carry voice data) for a recipient terminal.

On the start of the voice spurt, the quality of a radio channel used is determined based on say 20 ms period and correspondingly radio transmission parameters such as used radio channel parameters like frequency and time slot are defined and signalled to the recipient terminal for use throughout the starting voice spurt.

Each talk spurt usually lasts for several seconds. Talk spurt length is usually modelled as a negative exponential distribution with low bound as shown in FIG. 1. The mean length of talk spurts is about 2 to 3 seconds and the high end tail is shown in FIG. 1 to last about 10 seconds or more whereas the low end is typically bound at around 1 second. Conversely, during a voice spurt, semi-persistent scheduling and communication over traffic channel are based on conditions which prevailed on start of the talk spurt.

In VoIP, speech is typically encoded and later decoded using encoders and decoders optimised for speech. Speech has substantial amount of redundancy that may be compressed with so-called inter-coding, where previously encoded data is used in encoding subsequent data packets. Inter-coding greatly compresses voice data by making use of its inherent redundancy. However, the major compression ability comes at the cost that losing a single packet may prevent decoding of all subsequent packets. Hence, if applied to EUTRA VoIP where the semi-persistent models define transmission parameters for the whole voice spurt based on a very brief sample at the start of the spurt, there is a great risk that deteriorating radio channel will lead into major degradation in reconstructed voice quality at the recipient terminal.

Presents proposals for enhancing scheduling of VoIP data packets in the EUTRA make different compromises between layer 1 and 2 signalling, scheduling complexity and traffic channel use efficiency. It is desired to reach alternative solution that spares layer 1 and layer 2 signalling without an undue cost on traffic channel efficiency.

### SUMMARY

According to a first aspect of the invention there is provided a method comprising:
sending voice over internet protocol (VoIP) data packets of voice spurts to a radio link, which radio link has given resources usable for the sending of the VoIP data packets according to a predetermined schedule;
causing a change in the schedule; and
containing in data link layer padding bits of the VoIP data packets scheduling information associated with the change in the schedule.

Advantageously, the scheduling of the radio link may be adapted during the transferring of VoIP data packets of a given voice spurt. Hence, diversity and robustness of transfer may be enhanced in comparison to maintaining the radio link unchanged throughout each voice spurt.

The inventors have realised that the conditions may rapidly change during the voice spurt. While radio transmission parameters defined for the transmissions carrying the serial VoIP data packets are originally optimised based on a small portion of each talk spurt, the changing of the scheduling of the use of radio resources during the voice spurt increases flexibility and efficiency of scheduling of VoIP data traffic. The method of the first aspect may thus significantly enhance the performance of semi-persistent VoIP scheduling.

The radio link may be a link between a base station and mobile station of a telecommunications network.

The base station may be an enhanced node b (eNB) in the Evolved Universal Terrestrial Radio Access (EUTRA). The eNB may comprise a scheduler that is configured to define physical resource blocks (PRBs) for use in transmission of VoIP data packets between the base station and the mobile station.

The changing of the schedule may comprise any of:
changing the number of physical resource blocks allocated for transferring the VoIP data packets on the radio link;
changing to use one physical resource block instead another in transferring the VoIP data packets on the radio link; and
changing of scheduling of the transmission of VoIP data packets to use another radio channel in transferring the VoIP data packets on the radio link.

A series of initial VoIP data packets may be scheduled at the start of a voice spurt and the scheduling may be communicated from the base station to the mobile station. An initial VoIP data packet refers to a data packet that is sent as a member of a train of planned packets which convey audio coding data each for an interval of one or more speech coding frames. If an initial VoIP data packet is lost, a retransmission or generally corrective VoIP packet may be sent as a remedy for a lost VoIP data packet.

Advantageously, the scheduling of initial VoIP data packets may be changed during the period of the voice spurt and indicated to the recipient typically without new physical messaging by using otherwise unnecessary padding bits, because the data link layer (OSI model layer 2) messages on the radio link are commonly padded with redundant bits.

The changing of the schedule may be responsive to a change in the quality of the radio link. Advantageously, it may be possible to improve quality of radio interface during the period of the voice spurt to avoid severe impairment of voice quality. Moreover, the scheduling may be adapted by changing one recipient to use another channel that is not necessarily better in order to free resources on its channel for other use such as for another VoIP recipient. This may be useful if the same radio channel provides drastically different a reception quality for two mobile stations or terminals and by changing channel allocation neither recipient is substantially harmed but one is significantly helped.

The changing of the scheduling of the transmission of the serial VoIP data packets may be identified by means of predetermined bit patterns. The bit patterns may be defined to identify maintaining present channel, moving to a preceding or next channel as defined by channel number or frequency, for instance. Such use of bit pattern may operate with merely two padding bits. If more padding bits are available, further transmission parameters may be defined such as modulation and coding scheme (MCS) and Number of Physical Resource Block (PRB).

The identifying of the changing of the scheduling of the transmission of the serial VoIP data packets may be provided in the padding bits of two or more different VoIP data packets in order to provide interference resilience.

The changing of the scheduling of the transmission of the serial VoIP data packets may take place at predetermined intervals. The predetermined intervals may be set by the sender, by the scheduler or by any network entity based on input from the scheduler and/or the sender. The intervals may range from 0.2 to 3 seconds, suitably from 0.5 to 1 second inclusive of these exemplary bounds. For instance, 0.5 second would correspond to 25 VoIP packets each corresponding to 20 ms of speech (or other audio content as the case may be with VoIP).

The mobile station may further be configured to perform blind detection of the change in the scheduling if scheduling signalling is lost as may happen in some cases. The blind detection is the simpler the fewer different channels there are to test.

Further advantageously, the method may further include changing physical radio resources used in the radio interface in transmission of given serial VoIP data packets based on signalling provided to the recipient in the data link layer padding bits.

The radio link may be a link between a mobile station and a base station and the changing of the schedule may comprise changing any of:
a radio channel that is configured to carry VoIP data packets from the base station to the mobile station;
a radio channel that is configured to carry VoIP data packets from the mobile station to the base station; and
both a radio channel that is configured to carry VoIP data packets from the base station to the mobile station and a radio channel that is configured to carry VoIP data packets from the mobile station to the base station.

The changing of a channel may involve changing from one channel to another or changing properties such as a bit rate or transmission power of a given channel.

The scheduling information may comprise any of:
an indication of a change in a VoIP data packet buffer, from a mobile station to a base station;
an indication of a request to change a coding mode, from a mobile station to a base station;
a combination of an indication of a change in a VoIP data packet buffer and an indication of a request to change a coding mode, from a mobile station to a base station; and
an indication of a change in scheduling of physical resources, from a base station to a mobile station.

The coding mode may be conveniently changed particularly if adaptive multi-rate coding is used in audio coding of the VoIP data packets. By reducing coding bit rate necessary data transmission rate can be responsively reduced, which is particularly useful in interference-limited communication technologies such as the Code Division Multiple Access (CDMA).

The causing of the change in the schedule may comprise causing of sending to a network entity a request or status indication configured to cause the network entity to change the schedule; and the scheduling information may be configured to carry said request or status indication. According to a second aspect of the invention, there is provided a method comprising:
receiving voice over internet protocol (VoIP) data packets of voice spurts from a radio link, which radio link has given resources usable for the transferring of the VoIP data packets according to a predetermined schedule;
obtaining from data link layer padding bits of the VoIP data packets scheduling information associated with a change in the schedule; and
causing receiving of VoIP data packets according to the change in the schedule.

Advantageously, after the schedule is changed, VoIP data packets may be received using the radio link resources according to the new schedule until a next change in the schedule takes place.

According to a third aspect of the invention there is provided an apparatus comprising:
an output configured to send voice over internet protocol (VoIP) data packets of voice spurts to a radio link, which radio link has given resources usable for the sending of the VoIP data packets according to a predetermined schedule; and
a processor configured to cause a change in the schedule and to contain in data link layer padding bits of the VoIP data packets scheduling information associated with the change in the schedule.

According to a fourth aspect of the invention there is provided an apparatus comprising:
an input configured to receive voice over internet protocol (VoIP) data packets of voice spurts from a radio link, which radio link has given resources usable for the transferring of the VoIP data packets according to a predetermined schedule;
a processor configured to obtain from data link layer padding bits of the VoIP data packets scheduling information associated with a change in the schedule and to cause receiving of VoIP data packets according to the change in the schedule.

According to a fifth aspect of the invention, there is provided a computer program embodied in a computer readable memory medium, the computer program comprising computer executable program code configured to enable a telecommunications apparatus to perform:
sending voice over internet protocol (VoIP) data packets of voice spurts to a radio link, which radio link has given resources usable for the sending of the VoIP data packets according to a predetermined schedule;
causing a change in the schedule; and
containing in data link layer padding bits of the VoIP data packets scheduling information associated with the change in the schedule.

According to a sixth aspect of the invention, there is provided a computer program embodied in a computer readable memory medium, the computer program comprising computer executable program code configured to enable a telecommunications apparatus to perform:
receiving voice over internet protocol (VoIP) data packets of voice spurts from a radio link, which radio link has given resources usable for the transferring of the VoIP data packets according to a predetermined schedule;
obtaining from data link layer padding bits of the VoIP data packets scheduling information associated with a change in the schedule; and
causing receiving of VoIP data packets according to the change in the schedule.

According to a seventh aspect of the invention, there is provided an apparatus comprising:
means for sending voice over internet protocol (VoIP) data packets of voice spurts to a radio link, which radio link has given resources usable for the sending of the VoIP data packets according to a predetermined schedule;
means for causing a change in the schedule; and
means for containing in data link layer padding bits of the VoIP data packets scheduling information associated with the change in the schedule.

The memory medium may be a digital data storage such as a data disc or diskette, optical storage, magnetic storage, holographic storage, phase-change storage (PCM) or opto-magnetic storage. The memory medium may be formed into a device without other substantial functions than storing memory or it may be formed as part of a device with other functions, including but not limited to a memory of a computer, a chip set, and a sub assembly of an electronic device.

Various embodiments of the present invention have been illustrated only with reference to certain aspects of the invention. It should be appreciated that corresponding embodiments may apply to other aspects as well.

### BRIEF DESCRIPTION OF THE DRAWINGS

The invention will be described, by way of example only, with reference to the accompanying drawings, in which:

FIG. 1 shows a model of talk spurt length as a negative exponential distribution;

FIG. 2 shows a block diagram of a system according to an embodiment of the invention;

FIG. 3 shows a block diagram of a scheduler according to an embodiment of the invention;

FIG. 4 shows a block diagram of a terminal according to an embodiment of the invention;

FIG. 5 shows a schematic diagram of scheduling of a series of voice over internet protocol (VoIP) data packets for transmission to a recipient mobile station according to an embodiment of the invention;

FIG. 6 shows main signalling according to an embodiment of the invention;

FIG. 7 shows a schematic diagram of a layer 2 plane of a Voice Over Internet Protocol (VoIP) data packet with padding bits used according to different embodiments of the invention;

FIG. 8 illustrates a process in which a mobile station communicates with a scheduler;

FIGS. 9 and 10 schematically illustrate different uplink VoIP data packets;

FIG. 11 shows an example of using a single bit in-band signalling;

FIG. 12 shows an example of signalling resource allocation changes between different talk spurts; and

FIG. 13 illustrates the effect of an embodiment of the invention by two different curves plotted for two different resource continuances.

### DETAILED DESCRIPTION

In the following description, like numbers denote like elements.

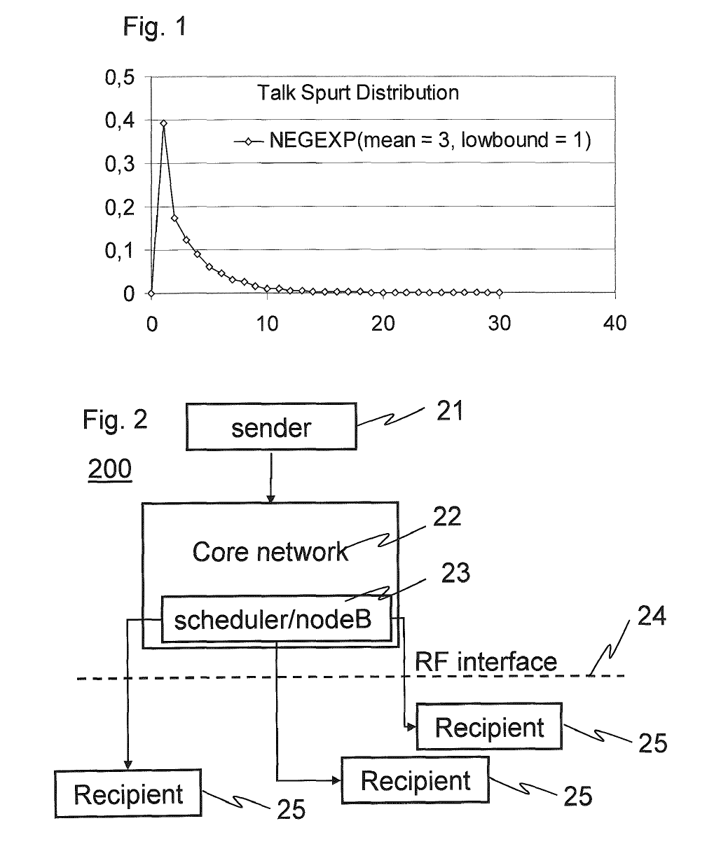

FIG. 1 has been discussed in the foregoing.

FIG. 2 shows a block diagram of a system according to an embodiment of the invention. The system comprises a sender 21, that is typically a cellular terminal such as a W-CDMA telephone, a core network 22 including a scheduler 23, and connected to the scheduler 23 over a radio interface 24 there are different recipient mobile stations 25 such as cellular terminals. Same terminals may operate as a sender or as a recipient Mobile Station (MS) in different calls, if support of both sending and receiving Voice Over Internet Protocol (VoIP) is supported. Here, in sake of simplicity, one terminal is referred to as a sender and the receiving end as a recipient.

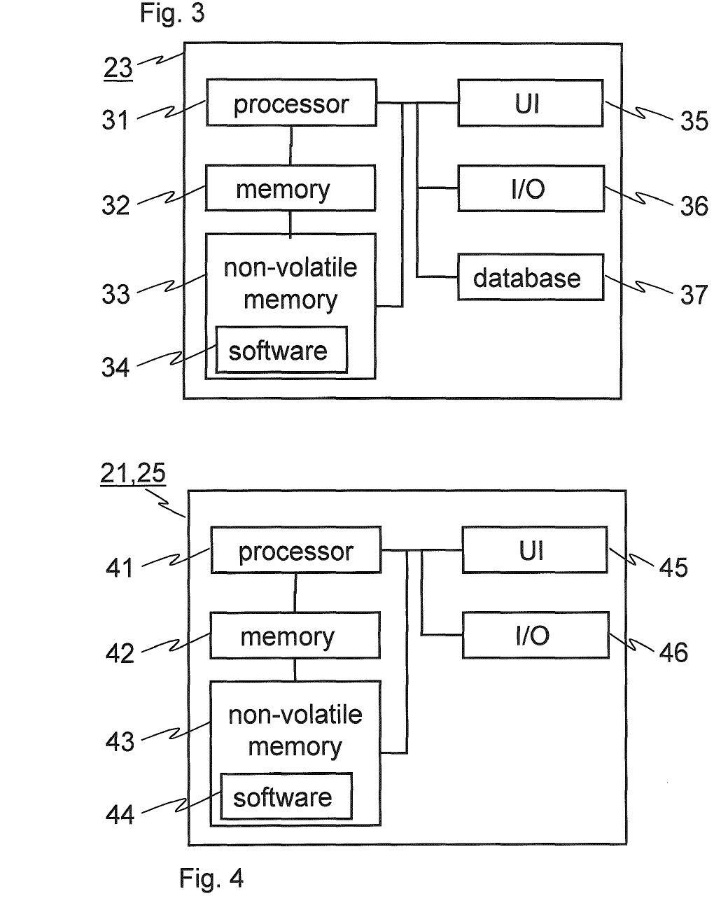

FIG. 3 shows a block diagram of an embodiment of a scheduler 23. The scheduler is typically a server computer that comprises a processor 31, a memory 32 for use by the processor to control the operation of the scheduler 23, a non-volatile memory 33 for storing long-term data such as software 34 comprising an operating system and computer executable applications, a user interface 35 for possible local configuration of the scheduler 23, an input/output system 36 for communication with entities such as the sender 21 and recipient 25.

FIG. 4 shows a block diagram of a computer 21,25 suitable for use as a sender 21 or recipient 25 in a system 200 of FIG. 1. The computer 21,25 comprises a processor 41, a memory 42 for use by the processor to control the operation of the computer 21,25, a non-volatile memory 43 for storing long-term data such as software 44 comprising an operating system and computer executable applications, a user interface 45 for user interaction such as voice input and/or output, and an input/output system 46 for communication with entities such as the scheduler 23.

The processor 31,41 in any one of the scheduler, sender or recipient MS may be a master control unit MCU. Alternatively, the processor may be a microprocessor, a digital signal processor, an application specific integrated circuit, a field programmable gate array, a microcontroller or a combination of such elements.

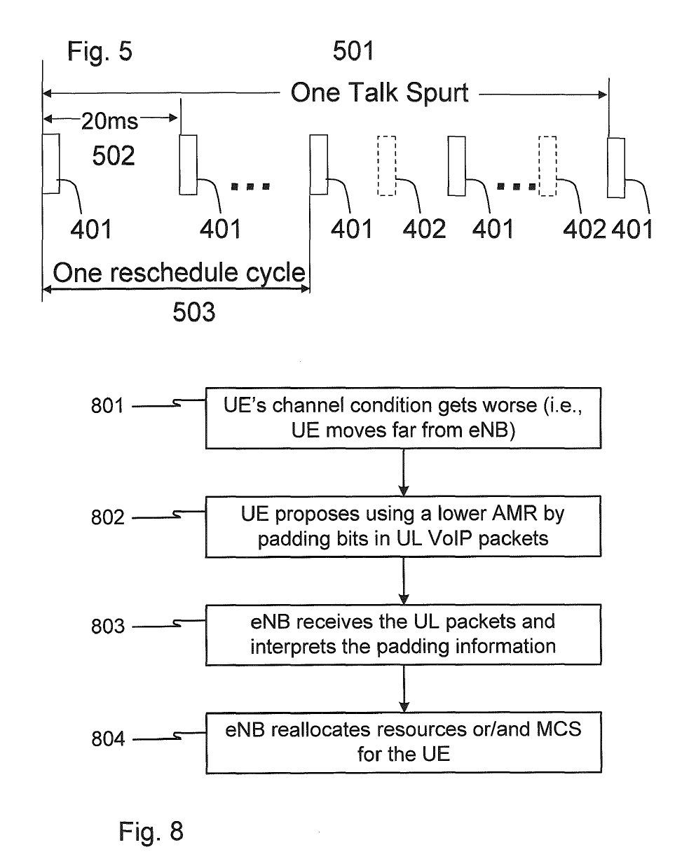

FIG. 5 shows a schematic diagram of scheduling of a series of voice over internet protocol (VoIP) data packets for transmission to a recipient according to an embodiment of the invention. FIG. 5 shows scheduled transmission timing for initial VoIP packets 401 spreading with a regular interval 502 over one talk spurt 501. FIG. 5 further illustrates one reschedule cycle 503. FIG. 5 also shows transmission slots 402 for retransmission VoIP data packets. The serial VoIP data packets, that is, the initial VoIP data packets, are first scheduled in connection of scheduling the talk spurt until its end even though the duration of the spurt is not yet known at initial scheduling. In course of the talk spurt, new initial VoIP data packets are sent as scheduled. After each reschedule cycle 503, the scheduler either maintains or changes the physical channel (or physical resource block) in an attempt to enhance diversity in the delivery of VoIP data packets to the recipient.

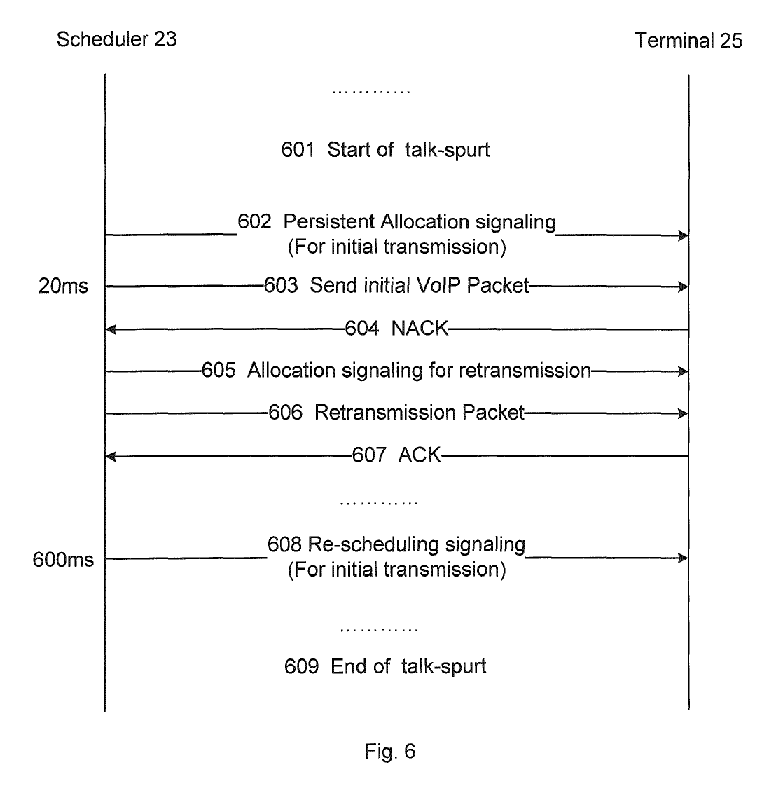

The rescheduling of initial VoIP data packets and scheduling of retransmissions are further explained in connection with FIG. 6.

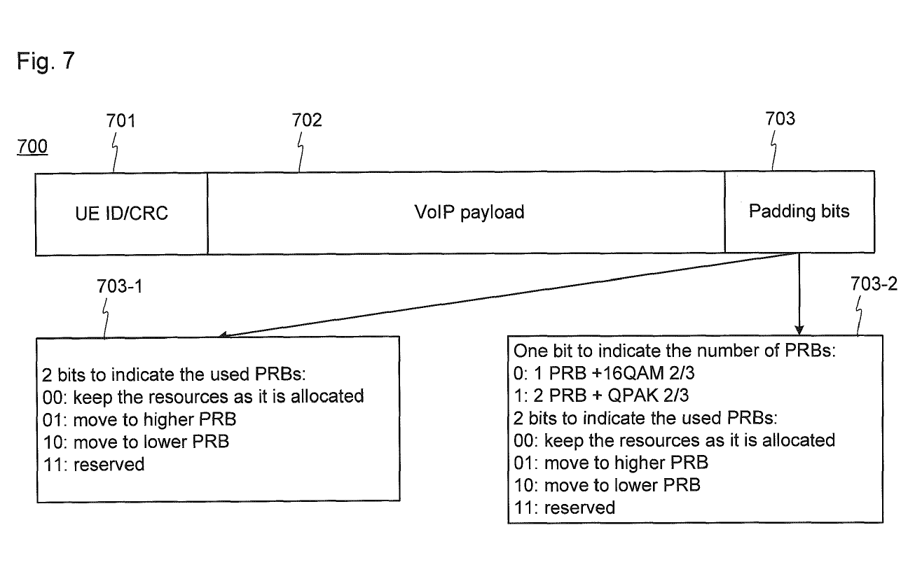

FIG. 6 shows main signalling according to an embodiment of the invention. The signalling between the scheduler (typically EnodeB, often also referred to as an eNB or enhanced node b in 3GPP EUTRA terminology) is shown from start of a talk spurt, 601. Next, persistent allocation signalling for initial transmissions is performed 602. With the persistent allocation the scheduler 23 defines a default allocation for the duration of the commencing talk spurt so that if no changes are made, that allocation will be applied to each initial transmission of VoIP packets. Next, initial VoIP packets are sent 603 from the eNB to the terminal 25. If such an error occurs over transmission path that the error is not correctable by possible error correction measures used, then a NACK 604 is sent, typically using the Hybrid automatic repeat request (HARQ) when supported. Responsively, allocation signalling for retransmission is sent 605 from the scheduler 23 to the recipient 25 and then a retransmission packet is sent 606 using allocated resources. Signalling 605 and 606 naturally may not occur, if the connection is good, or may occur more than once or at varying time and errors may also occur in the retransmission in which case a further retransmission may be sent. In any case, after successful transmission of the retransmission packet a positive acknowledgement (ACK 607) is typically sent back from the terminal 25 to the eNB 23. The process of sending initial VoIP data packets continues while the talk spurt lasts until after a given time, the scheduling is adapted based on then current circumstances. The adapted scheduling or rescheduling with other word is signalled from the scheduler 23 to the terminal 25 using layer 2 padding of VoIP packets, as is further illustrated with reference to FIG. 7.

The period between initial transmissions is typically 20 millisecond (ms). The interval in which re-scheduling of initial transmissions is performed is a value subject to optimising the operation of the network. In an embodiment of the invention, the re-scheduling interval is partly or entirely determined by the terminal 25. The interval is typically between 0.5 s and 2 s. There is a trade-off between better adaptation to changes in radio connection quality and load with shorter interval and smaller signalling overhead caused by re-scheduling with longer interval. In an embodiment of the invention, the interval is further adapted so that major changes in the quality of connection trigger shortened or longer intervals depending on whether the connection has deteriorated or enhanced, respectively.

FIG. 7 shows a schematic diagram of a layer 2 plane of a Voice Over Internet Protocol (VoIP) data packet 700 with padding bits used according to different embodiments of the invention. The VoIP data packet contains a header portion 701 with destination terminal identification and error correction data, a VoIP payload 702 that carries audio coded payload data, and padding information 703 that contains a set of padding bits to fill the packet to its predefined total length of bits. Depending on the amount of padding bits available in the VoIP data packet 700 and on the embodiment of the invention, different information is conveyed from the scheduler 23 to the terminal 25 as is illustrated by two different break-down views into the padding bits 703, shown as alternatives 703-1 and, 703-2, respectively. Hence, one or more VoIP data packets with the structure shown in FIG. 7 may convey information for rescheduling initial transmissions. In a first case, the padding information contains a set of given two bits 703-1 which designate the used physical resource blocks (PRB) so that one combination of the padding bits 703-1 directs the terminal 25 not to alter the scheduling, two other combinations of the padding bits 703-1 direct the terminal 25 to move to a PRB with a higher and lower reference number respectively and one combination of the padding bits 703-1 is reserved.

The reserved combination of the padding bits may indicate altering the re-scheduling interval in one embodiment and additionally changing to a higher or lower PRB in another embodiment. The altering of the re-scheduling interval may be such that in the absence of retransmissions, the re-scheduling interval is increased according to a predetermined scheme for new retransmission intervals and after a given number of retransmissions within one re-scheduling interval, the reserved combination is applied to indicate that the re-scheduling interval shall be shortened.

The first alternative embodiment for the use of padding bits 703-1 may be seen to instruct the terminal the PRBs used for initial transmissions in the next re-scheduling interval on the downlink that is for VoIP data packets from the eNB 23 to the terminal 25.

In the second alternative embodiment for the use of the padding bits 703-2, the terminal 25 is informed both on the amount of PRBs used in the following re-scheduling interval and whether the resources allocated for the following re-scheduling interval should use the same, higher or lower PRB. Further, among the options for the resource use in the following re-scheduling interval there is provided a combination of a sub-set of the padding bits 703-2 indicative of a reserved combination. The reserved combination may be used for corresponding function as was explained in connection with the first alternative embodiment for the use of the padding bits 703-1.

In a further embodiment of the invention, the terminal 25 is capable of adjusting audio transfer on the uplink to the eNB 23 using L2 padding bits in uplink VoIP data packets. FIG. 8 illustrates a process in which a mobile station, or more exactly user equipment (UE) communicates with a scheduler or eNB. The UE detects that the channel conditions have impaired 801 when, for instance, the mobile station moves far from the eNB 23 or to a radio signal shadow. The UE next proposes 802 using a lower adaptive multirate (AMR) mode by embedding a corresponding signal into padding of one or more uplink VoIP data packets. The eNB then receives the uplink VoIP data packets with the padding inserted by the UE 25 and interprets the padding information. On detecting that the UE has requested the lower AMR mode and the eNB reschedules the uplink resources. The eNB may then notify the rescheduling by using downlink data link layer padding of VoIP data packets or by using any other method such as prior known layer 3 signalling.

It should be appreciated that the process of FIG. 8 is equally applicable to communicating any other adaptation information for adapting the radio link between the mobile station 25 and the eNB 23, or generally for changing the scheduling of radio resource use. For instance, the MS may transmit a Modulation and Coding mode Scheme (MCS) indication to inform a change that will be effected of the mobile station's own initiative or to request a change in the MCS. The adaptation information may also convey an indication of the present packet buffer state at the mobile station 25.

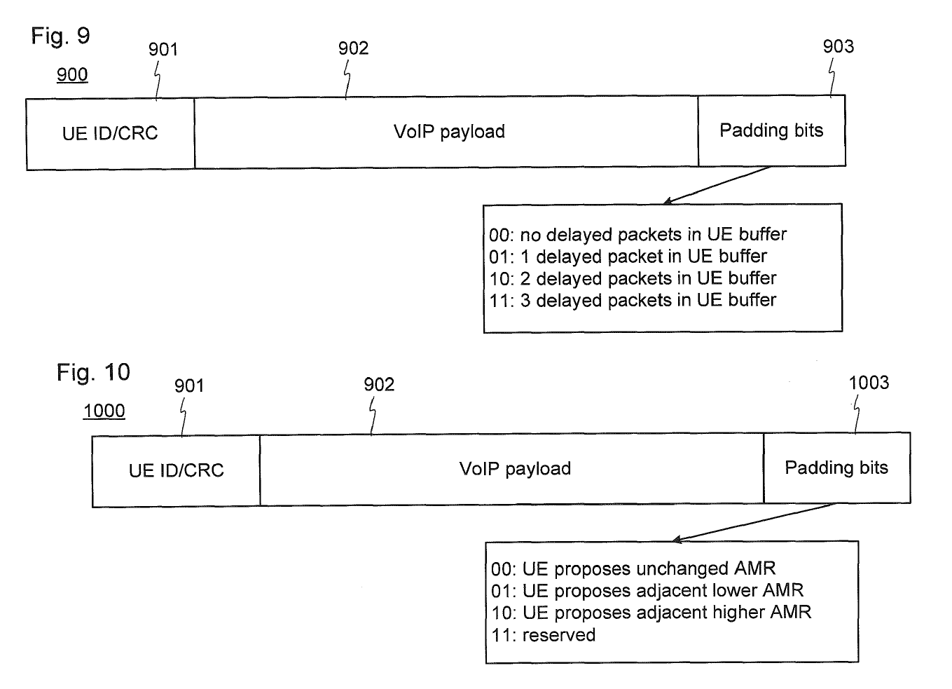

FIGS. 9 and 10 schematically illustrate different uplink VoIP data packets 900 and 1000, respectively. Both packets comprise similarly a header 901 with a UE identifier and error detection and/or correction information such as a cyclic redundancy code CRC, a VoIP data payload 902 and a set of padding bits denoted as 903 and 1003, respectively in FIGS. 9 and 10. The padding bits 903 are configured to indicate to the eNB 23 the status of delayed VoIP data packets in a buffer of the UE 25. In this example, different bit combinations illustrate amounts of delayed packets in the buffer ranging from 0 to 3. Other implementations are also contemplated e.g. that the different bit combinations correspond to different linearly developing intervals of amounts such as 0 to 2, 3 to 5, 6 to 8, and 9 to 11 or exponential intervals of amounts such as 0, 1 to 2, 3 to 6, and 7 to 14 (or at least 7) in which example each range has twice the breadth of its precedent range.

The padding bits 1003 in FIG. 10 indicate to the eNB 23 different requests for maintaining or changing the coding mode according to a predetermined scheme.

The embodiments presented in the foregoing are generally effective and efficient and they may enable improving frequency diversity usage during relatively long talk spurts. However, sometimes, the voice talk-spurts may be relatively short and the channel condition may remain constant or change insignificantly during several sequential talk-spurts. For instance, the mobile station 25 may stay in one place or move relatively slowly (e.g. walking speed) and the speech may contain numerous short spurts short talk spurts such as commands or instructions so that there are many short pauses. If explicit persistent allocation signalling is sent regardless of whether the allocated resources are changed among the consecutive talk spurt, same explicit signalling has to be repeated thereby causing unnecessary signalling. Even if the amount required by the signalling may be greatly reduced from prior known techniques, it is yet desirable to improve radio resource usage and/or at least provide other alternatives. To this end, different embodiments of the invention seek to avoid repeated explicit signalling.

In one alternative, in-band signalling in downlink a VoIP data packet is used to instruct the mobile station 25 to adhere to its previous allocation. In another alternative, silent control is applied such that when an e-NB receives “resource request” signalling from the mobile station 25 at the start of a talk spurt but sends no reply, then UE expects that it should use previous resources for this spurt. If the resource allocation should be changed, the e-NB sends explicit signalling to respectively instruct the mobile station 25 for use in a commencing talk spurt.

The first alternative for avoiding repeated explicit signalling is next described in more detail. Let us assume that there is on-going downlink and uplink data transmission. The eNB 23 then receives a the “Resource Request” from the mobile station 25 for coming talk-spurt. The eNB 23 decides to maintain the uplink resources (such as frequency and MCS). The eNB 23 sends an indication of resource continuance to the mobile station 25 by using padding bits or puncture bits in the downlink VoIP data packets (both new transmission and retransmission of DL packets are applicable)

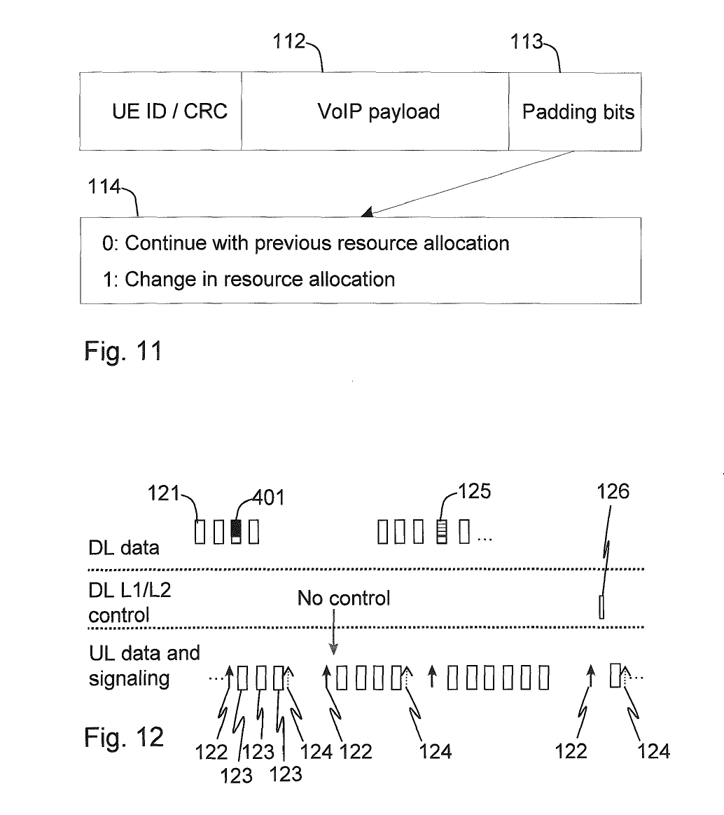

FIG. 11 shows an example of using a single bit in-band signalling. In this example, a VoIP data packet comprises a header 111 with an identifier for the mobile station 25 and a checksum for error detection and payload 112 that is extended with padding bits 113 to fill the size of the VoIP data packet. At simplest, one value 114 of the padding bits such as 0 is used to instruct the mobile station 25 to use the same resources as with current/previous talk-spurt and another value such as 1 is used to instruct the mobile station 25 to use different resources so that the mobile station 25 should obtain from the eNB 23 its new resource allocation for the uplink.

The other alternative for avoiding repeated explicit signalling is next described in more detail. This embodiment is particularly useful when there is no on-going downlink data transmission into which the in-band signalling could be included. In order to avoid introducing explicit new signalling when the resource allocation for the uplink is maintained, the eNB 23 may interpret lack of explicit signalling as an indirect or silent control to maintain the resource allocation used in previous talk spurt. Only if the eNB 23 changes the resource allocation for the mobile station 25, the eNB 23 uses control signalling. Hence, no additional signalling or padding bits are needed in this method.

It is appreciated that relying to correct interpretation to missing signal, possibly of a single bit, may be exposed to errors in case that the signalling is somehow lost on the radio link. Even though the likelihood of such an error is low, typically about 1%, further measures may be taken in order to avoid adverse consequences from the error. For instance, a timer can be used to cause the mobile station 25 to wait for a predetermined time for explicit control signalling and if none is received then the mobile station 25 starts transmitting next talk-spurt using the previous resource allocation used by its previous talk-spurt. The timer may be started when the mobile station 25 sends a resource allocation request for a new talk spurt.

FIG. 12 shows an example of signalling resource allocation changes between different talk spurts. FIG. 12 illustrates various messages on three levels of abstraction: downlink data; downlink control on OSI layer 1 or 2; and uplink data and signalling. FIG. 12 presents a series of messages and signals as spread onto a hypothetical time line as a simplification where only some items that are useful for illustrating embodiments are present.

In FIG. 12, a number of downlink data packets 121 are drawn. These packets are sent one by one and they carry one or more VoIP speech frames, often interlaced into two or more downlink data packets 121. At a given point of time, the mobile station 25 should start transmitting a talk spurt in data packets over the uplink. The mobile station 25 sends a request 122 to the eNB 23 and responsively the eNB sends to the mobile station 25 an initial VoIP data packet 401 with information about new scheduling of resources. In accordance with the first alternative mentioned in the foregoing, a single padding or puncturing bit may be used to inform if resource allocation will continue unchanged to the commencing talk spurt TS1 from the previous spurt (not shown). Once the mobile station 25 has sent all the buffered speech frames in VoIP data packets 123, the mobile station 25 sends a resource release message 124 to the eNB 23 in order to release its resources for other use. On start of the next talk spurt TS2, the mobile station 25 sends to the eNB 23 a new request 122 as previously. The mobile station 25 may be configured according to the another alternative that employs silent control such that on starting the request 122, the mobile station 25 also starts a timer and waits for a predetermined time for possible explicit signalling from the eNB 23. As no explicit resource allocation signalling follows the request 122, the mobile station 25 concludes that it should proceed using resource allocation known from preceding talk burst. The mobile station 25 then transmits VoIP data packets 123 until no more speech frames remain to be transmitted and the mobile station 25 sends a new release message 124 to release its radio resources.

FIG. 12 further shows a burst of downlink data packets which partly overlap with the start of next uplink burst from the mobile station 25. As the mobile station 25 sends a request 122 or more specifically the signalling of a response from the eNB co-insides with the downlink burst, a downlink data packet is used to convey an in-band indication that the resource allocation should remain unchanged with regard to the preceding talk burst. In this case, the downlink data packet used to convey the in-band signalling is a retransmission data packet 125. It is appreciated that retransmission data packets may be used to convey the inband resource allocation signalling like initial data packets. After the end of the talk spurt, the mobile station 25 sends a resource release message 124.

On start of the next talk spurt, the mobile station 25 sends a new request 122 as was also drawn for the preceding spurts, but in this case, the eNB 23 desires to change the resource allocation and sends a normal resource grant message 126. As there is no ongoing downlink transfer at this moment of time, the resource grant message 126 is sent as a separate message to the mobile station 25.

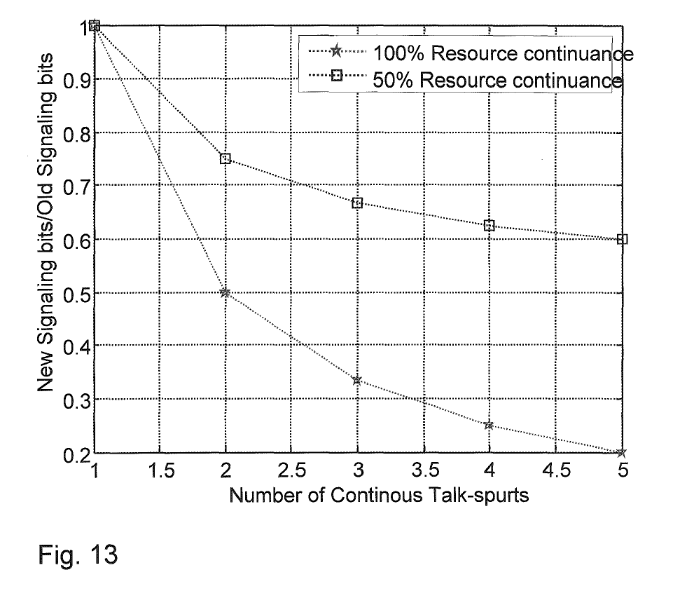

A normally skilled person appreciates that for cases when there are many frequent short-duration talk-spurts in speech that is being transmitted, the embodiments described in the foregoing may avoid unnecessary signalling and/or reduce resource allocation/grant signalling cost. Compared to a case where explicit control signalling is sent even when the resources for next talk-spurt need not be changed, substantial reduction in the signalling may be attained as shown in FIG. 13 with different scenarios for resource continuance.

It should be appreciated that whilst in the foregoing the uplink was used as an example, the first and other alternative embodiments apply equally for instructing the mobile station 25 on resource allocation for the downlink.

In FIG. 13, two different curves are plotted for two different resource continuances, wherein resource continuance refers to the probability X (0 . . . 1) in which following talk spurts is given unchanged resource allocation. The vertical axis of FIG. 13 shows the efficiency of signalling reduction based on the following equation 1:

$$new signalling bits \text{/} old signalling bits = \frac{1 + ( N - 1 ) \cdot ( 1 - X )}{N} \qquad ( 1 )$$

wherein N is the number of continuous talk-spurt. In equation 1, old signalling number may thus equal to N units of signalling, as each talk-spurt needs one signalling. New signalling amount is then 1+(N−1)*(1−X), because the first talk-spurt always needs one signalling unit and then the remaining number of talk-spurts less the first one use signalling units in extent (1−X).

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means without deviating from the characteristics of the invention. For instance, an EUTRA access network has been used as an example network in which different embodiments of the invention may be used, but it should be understood that the invention may find use in any types of radio systems such as IEEE 802.11 (WLAN), IEEE 802.16 (WiMAX), or ITU IMT-2000 (CDMA-2000).

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. A method comprising:
sending voice over internet protocol data packets of voice spurts to a radio link, which radio link has been allocated resources usable for the sending of the voice over internet protocol data packets, according to a schedule;
causing a change in the schedule during the transferring of voice over internet protocol data packets of a given voice spurt; and
containing, in data link layer padding bits of the voice over internet protocol data packets, scheduling information associated with the change in the schedule.

2-48. (canceled)

49. A method according to claim 1, wherein the changing of the schedule comprises at least one of:
changing the number of physical resource blocks allocated for transferring the voice over internet protocol data packets on the radio link;
changing to use one physical resource block instead of another in transferring the voice over internet protocol data packets on the radio link; and
changing to use another radio channel in transferring the voice over internet protocol data packets on the radio link.

50. A method according to claim 1, wherein the radio link is a link between a mobile station and a base station and the changing of the schedule comprises changing at least one of:
a radio channel for carrying voice over internet protocol data packets from the base station to the mobile station; and
a radio channel for carrying voice over internet protocol data packets from the mobile station to the base station.

51. A method according to claim 1, wherein the scheduling information comprises at least one of:
an indication of a change in a voice over internet protocol data packet buffer, from a mobile station to a base station;
an indication of a request to change a coding mode, from a mobile station to a base station; and
an indication of a change in scheduling of physical resources, from a base station to a mobile station.

52. A method according to claim 1, further comprising:
transmitting to the radio link, voice over internet protocol data packets of a first voice spurt and of a second voice spurt sequentially following the first voice spurt;
obtaining a first resource allocation;
transmitting over the radio link the data packets of the first voice spurt using the first resource allocation;
releasing the radio link after the data packets of the first voice spurt have been transmitted;
requesting a second resource allocation for transmitting over the radio link the data packets of the first voice spurt; and
determining that the second resource allocation corresponds to the first resource allocation.

53. A method comprising:
receiving voice over internet protocol data packets of voice spurts from a radio link, which radio link has been allocated resources usable for the transferring of the voice over internet protocol data packets, according to a schedule;
obtaining, from data link layer padding bits of the voice over internet protocol data packets, scheduling information associated with a change in the schedule; and
receiving voice over internet protocol data packets according to the change in the schedule during receiving of voice over internet protocol data packets of a given voice spurt over the radio link.

54. A method according to claim 53, wherein the scheduling information comprises at least one of:
an indication of a change in a voice over internet protocol data packet buffer, from a mobile station to a base station;
an indication of a request to change a coding mode, from a mobile station to a base station; and
an indication of a change in scheduling of physical resources, from a base station to a mobile station.

55. A method according to claim 53, further comprising:
receiving from the radio link voice over internet protocol data packets of a first voice spurt and of a second voice spurt sequentially following the first voice spurt;
obtaining a first resource allocation;
receiving from the radio link the voice over internet protocol data packets of the first voice spurt using the first resource allocation;
releasing the radio link after the voice over internet protocol data packets of the first voice spurt have been transmitted;
receiving a request for a second resource allocation for transmitting over the radio link the voice over internet protocol data packets of the first voice spurt; and
identifying whether the second resource allocation corresponds to the first resource allocation.

56. An apparatus comprising:
an output configured to send voice over internet protocol data packets of voice spurts to a radio link, which radio link has been allocated resources usable for the sending of the voice over internet protocol data packets, according to a schedule; and
a processor configured to cause a change in the schedule during the transferring of voice over internet protocol data packets of a given voice spurt and to contain in data link layer padding bits of the voice over internet protocol data packets scheduling information associated with the change in the schedule.

57. An apparatus according to claim 56, wherein the causing of the change in the schedule comprises causing at least one of:
changing the number of physical resource blocks allocated for transferring the voice over internet protocol data packets on the radio link;
changing to use one physical resource block instead of another in transferring the voice over internet protocol data packets on the radio link; and
changing of scheduling of the transmission of voice over internet protocol data packets to use another radio channel in transferring the voice over internet protocol data packets on the radio link.

58. An apparatus according to claim 56, wherein the radio link has a variable quality and the apparatus is arranged to cause the change in the schedule responsive to a change in the quality of the radio link.

59. An apparatus according to claim 56, wherein the processor further configured to identify or provide identification of the change of the schedule by the padding bits of two or more different voice over internet protocol data packets.

60. An apparatus according to claim 56, wherein the radio link is a link between a mobile station and a base station and the causing of the change in the schedule comprises changing at least one of:
a radio channel for carrying voice over internet protocol data packets from the base station to the mobile station; and
a radio channel for carrying voice over internet protocol data packets from the mobile station to the base station.

61. An apparatus according to claim 56, wherein the scheduling information comprises at least one of:
an indication of a change in a voice over internet protocol data packet buffer, from a mobile station to a base station;
an indication of a request to change a coding mode, from a mobile station to a base station; and
an indication of a change in scheduling of physical resources, from a base station to a mobile station.

62. An apparatus according to claim 56, wherein
the causing of the change in the schedule comprises causing of sending to a network entity a request or status indication for causing the network entity to change the schedule; and
the scheduling information is set to carry said request or status indication.

63. An apparatus according to claim 56, wherein the processor further configured to:
transmit to the radio link voice over internet protocol data packets of a first voice spurt and of a second voice spurt sequentially following the first voice spurt;
obtain a first resource allocation;
transmit over the radio link the voice over internet protocol data packets of the first voice spurt using the first resource allocation;
release the radio link after the voice over internet protocol data packets of the first voice spurt have been transmitted;
request for a second resource allocation for transmitting over the radio link the voice over internet protocol data packets of the first voice spurt; and
determine that the second resource allocation corresponds to the first resource allocation.

64. An apparatus comprising:
an input configured to receive voice over internet protocol data packets of voice spurts from a radio link, which radio link has been allocated resources usable for the transferring of the voice over internet protocol data packets, according to a schedule;
a processor configured to obtain from data link layer padding bits of the voice over internet protocol data packets scheduling information associated with a change in the schedule and to receive voice over internet protocol data packets according to the change in the schedule during receiving of voice over internet protocol data packets of a given voice spurt over the radio link.

65. An apparatus according to claim 64, wherein the changing of the schedule comprises at least one of:
changing the number of physical resource blocks allocated for transferring the voice over internet protocol data packets on the radio link;
changing to use one physical resource block instead of another in transferring the voice over internet protocol data packets on the radio link; and
changing of scheduling of the transmission of voice over internet protocol data packets to use another radio channel in transferring the voice over internet protocol data packets on the radio link.

66. An apparatus according to claim 64, further comprising a detector configured to perform blind detection of the change in the scheduling if scheduling signalling is lost.

67. An apparatus according to claim 64, wherein the radio link is a link between a mobile station and a base station and the changing of the schedule comprises changing at least one of:
a radio channel configured to carry voice over internet protocol data packets from the base station to the mobile station; and
a radio channel configured to carry voice over internet protocol data packets from the mobile station to the base station.

68. An apparatus according to claim 64, wherein the scheduling information comprises at least one of:
an indication of a change in a voice over internet protocol data packet buffer, from a mobile station to a base station;
an indication of a request to change a coding mode, from a mobile station to a base station; and
an indication of a change in scheduling of physical resources, from a base station to a mobile station.

69. An apparatus according to claim 64, wherein the processor further configured to:
receive from the radio link voice over internet protocol data packets of a first voice spurt and a second voice spurt sequentially following the first voice spurt;
obtain a first resource allocation;
receive from the radio link the voice over internet protocol data packets of the first voice spurt using the first resource allocation;
release the radio link after the voice over internet protocol data packets of the first voice spurt have been transmitted;
receive a request for a second resource allocation for transmitting over the radio link the voice over internet protocol data packets of the first voice spurt; and
identify whether the second resource allocation corresponds to the first resource allocation.

70. A computer program embodied in a computer readable memory medium, the computer program comprising:
computer executable program code which when executed by the computer enables the computer to send voice over internet protocol data packets of voice spurts to a radio link, which radio link has been allocated resources usable for the sending of the voice over internet protocol data packets, according to a schedule;
computer executable program code which when executed by the computer enables the computer to cause a change in the schedule during the transferring of voice over internet protocol data packets of a given voice spurt; and
computer executable program code which when executed by the computer enables the computer to contain in data link layer padding bits of the voice over internet protocol data packets scheduling information associated with the change in the schedule.

71. A computer program embodied in a computer readable memory medium, the computer program comprising:
computer executable program code which when executed by the computer enables the computer to receive voice over internet protocol data packets of voice spurts from a radio link, which radio link has been allocated resources usable for the transferring of the voice over internet protocol data packets, according to a schedule;
computer executable program code which when executed by the computer enables the computer to obtain from data link layer padding bits of the voice over internet protocol data packets scheduling information associated with a change in the schedule; and
computer executable program code which when executed by the computer enables the computer to receive voice over internet protocol data packets according to the change in the schedule during receiving of voice over internet protocol data packets of a given voice spurt over the radio link.
